(19) United States
(12) Patent Application Publication
(10) Pub. No.: US 2010/0229090 A1
(43) Pub. Date: Sep. 9, 2010

(54) Systems and Methods for Interacting With Touch Displays Using Single-Touch and Multi-Touch Gestures

(75) Inventors: John David Newton, Auckland (NZ); Keith John Colson, Auckland (NZ)

Correspondence Address: JOHN S. PRATT, ESQ;KILPATRICK STOCKTON, LLP, 1100 PEACHTREE STREET, SUITE 2800, ATLANTA, GA, 30309, US

(73) Assignee: Next Holdings Limited, Auckland (NZ)

(21) Appl. No.: 12/717,232

(22) Filed: Mar. 4, 2010

(30) Foreign Application Priority Data
Mar. 5, 2009 (AU) 2009900960
Mar. 25, 2009 (AU) 2009901287

(51) Int. Cl. G06F 3/048; G06F 3/041; G06F 3/042

(52) U.S. Cl. 715/702; 345/173; 345/175; 715/764; 715/863

(57) ABSTRACT

Embodiments include position detection systems that can identify two touch locations mapped to positions proximate a GUI object, such as a boundary. In response to movement of one or both of the two touch locations, the GUI object can be affected, such as moving the boundary to resize a corresponding object and/or to relocate the boundary, or the GUI object can be selected without movement of the touch locations. Embodiments include single touch gestures, such as identifying a rolling, bending, or other movement occurring while a touch location remains substantially the same and interpreting the movement as an input command. Embodiments may utilize one or more optical sensors having sufficient sensitivity to recognize changes in detected light due to variations in object orientation, makeup or posture caused by the rolling, bending, and/or other movement(s).

### PRIORITY CLAIM

The present application claims priority to Australian provisional application no 2009900960, entitled, “A computing device comprising a touch sensitive display,” filed Mar. 5, 2009, which is incorporated by reference herein in its entirety; the present application also claims priority to Australian provisional application no. 2009901287, entitled, “A computing device having a touch sensitive display,” filed Mar. 25, 2009, which is incorporated by reference herein in its entirety.

### BACKGROUND

Touch-enabled devices have become increasingly popular. A touch-enabled device can include one or more touch surfaces defining an input area for the device. For example, a touch surface may correspond to a device screen, a layer of material over a screen, or an input area separate from the display, such as a trackpad. Various technologies can be used to determine the location of a touch in the touch area, including, but not limited to, resistive, capacitive, and optical-based sensors. Some touch-enabled systems, including certain optical systems, can determine a location of an object such as a stylus or finger even without contact between the object and the touch surface and thus may be more generally deemed “position detection systems.”

Touch-enabled devices can be used for so-called multitouch input—i.e., gestures utilizing more than one simultaneous touch—and thus require multiple points of contact (e.g., for pinch, rotate, and other gestures).

Other inputs for touch-enabled devices are modeled on non-touch input techniques, such as recognizing a touch as a click event. For example, one of the actions available to a user can include the ability to resize on-screen graphical user interface (GUI) objects, such as windows. One conventional method of resizing is to click and hold a mouse button at an external border of the object to be resized and then drag in one or more directions.

### SUMMARY

Embodiments configured in accordance with one or more aspects of the present subject matter can provide for a more efficient and enjoyable user experience with a touch-enabled device. Some embodiments may additionally or alternatively allow for use of input gestures during which the touch location remains substantially the same.

One embodiment comprises a system having a processor interfaced to one or more sensors, the sensor(s) configured to identify at least two touch locations on a touch surface. The processor can be configured to allow for use of a resizing or dragging action that can reduce or avoid problems due to the relatively small pixel size of an object border on a touch screen as compared to a touch location. Particularly, the processor can be configured to identify two touch locations mapped to positions proximate a GUI object such as a boundary. In some embodiments, in response to movement of one or both of the two touch locations, the GUI object can be affected, such as moving the boundary to resize a corresponding object and/or to relocate the boundary.

One embodiment allows for use of single- or multi-touch input gestures during which the touch location remains the same or substantially the same. This can, in some instances, reduce or eliminate user irritation or inconvenience due to complicated multitouch movements. For example, the processor may utilize one or more optical sensors to identify touch locations based in interference with an expected pattern of light. The optical sensors may have sufficient sensitivity for the processor to recognize changes in detected light due to variations in object orientation, makeup or posture, such as changes due to rolling and/or bending movements of a user's finger. The rolling, bending, and/or other movement(s) can be interpreted as commands for actions including (but not limited to) scrolling of a display area, linear movement of an object (e.g., menu items in a series), and/or rotation of an object. The technique may be used with non-optical detection systems as well.

These illustrative embodiments are mentioned not to limit or define the limits of the present subject matter, but to provide examples to aid understanding thereof. Illustrative embodiments are discussed in the Detailed Description, and further description is provided there, including illustrative embodiments of systems, methods, and computer-readable media providing one or more aspects of the present subject matter. Advantages offered by various embodiments may be further understood by examining this specification and/or by practicing one or more embodiments of the claimed subject matter.

### BRIEF DESCRIPTION OF THE DRAWINGS

A full and enabling disclosure is set forth more particularly in the remainder of the specification. The specification makes reference to the following appended figures.

FIG. 1 is a diagram showing an illustrative coordinate detection system.

FIG. 2A shows an illustrative embodiment of a coordinate detection system comprising an optical sensor.

FIG. 2B illustrates the coordinate detection system of FIG. 2A and how interference with light as used to identify a single-touch gesture.

FIGS. 2C and 2D illustrate example movements that can be used in identifying a single-touch gestures.

FIG. 3 is a flowchart showing steps in an exemplary method for identifying a single-touch gesture.

FIGS. 4A-4C illustrate exemplary graphical user interfaces during a multi-touch gesture.

FIG. 5 is a flowchart showing steps in an exemplary method for identifying a multi-touch gesture.

### DETAILED DESCRIPTION

Reference will now be made in detail to various and alternative exemplary embodiments and to the accompanying drawings. Each example is provided by way of explanation, and not as a limitation. It will be apparent to those skilled in the art that modifications and variations can be made. For instance, features illustrated or described as part of one embodiment may be used on another embodiment to yield a still further embodiment. Thus, it is intended that this disclosure includes modifications and variations as come within the scope of the appended claims and their equivalents.

In the following detailed description, numerous specific details are set forth to provide a thorough understanding of the claimed subject matter. However, it will be understood by those skilled in the art that claimed subject matter may be practiced without these specific details. In other instances, methods, apparatuses or systems that would be known by one of ordinary skill have not been described in detail so as not to obscure the claimed subject matter.

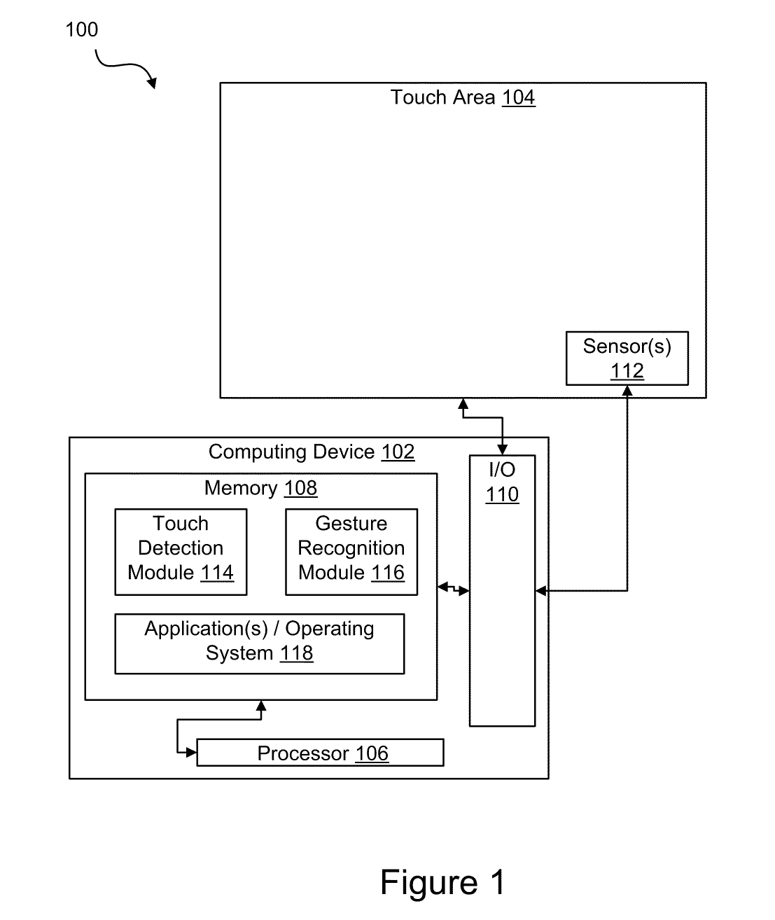

FIG. 1 is a diagram showing an illustrative position detection system 100. In this example, position detection system 100 comprises a computing device 102 that monitors a touch area 104 using one or more processors 106 configured by program components in memory 108. For example, processor 106 may comprise a microprocessor, a digital signal processor, or the like. Processor 106 can monitor touch area 104 via I/O interface 110 (which may represent one or more busses, interfaces, etc.) to connect to one or more sensors 112.

For example, computing device 102 may comprise a desktop, laptop, tablet, or “netbook” computer. However, other examples may comprise a mobile device (e.g., a media player, personal digital assistant, cellular telephone, etc.), or another computing system that includes one or more processors configured to function by program components. Touch area 104 may correspond to a display of the device and may be a separate unit as shown here or may be integrated into the same body as computing device 102. In some embodiments, computing device 102 may comprise a position detection system that is itself interfaced to another computing device. For example, processor 106, memory 108, and I/O interface 110 may be included in a digital signal processor (DSP) that is interfaced as part of an input device used for a computer, mobile device, etc.

Additionally, it will be understood that the principles disclosed herein can be applied when a surface separate from the display (e.g., a trackpad) is used for input, or could be applied even in the absence of a display screen when an input gesture is to be detected. For example, the touch area may feature a static image or no image at all, but may be used for input via one-finger or two-finger gestures.

Sensor(s) 112 can provide data indicating one or more touch locations relative to a touch surface, and may operate using any number or type of principles. For example, sensor(s) 112 may, as explained below, comprise one or more optical sensors that can detect the locations of touches, hovers, or other user interactions based on interference with an expected pattern of light and/or by analyzing image content. Additionally or alternatively, sensor(s) 112 may comprise capacitive, resistive, and/or other sensors, such as an array that provides location data in response to contact by an object.

In this example, processor 106 can identify the one or more touch locations from the sensor data using program components embodied in memory. Particularly, touch detection module 114 can comprise one or more components that read and interpret data from sensor(s) 112. For instance, if optical sensors are used, module 114 can sample the sensors and use triangulation techniques to identify one or more touch locations and/or potential touch locations. As another example, if a grid or other array of resistive or capacitive sensors are used, the touch location can be identified from the location(s) at which the electrical characteristics change in a manner consistent with a touch. Module 114 may also perform signal processing routines, such as filtering data from sensors 112, driving light or other energy sources, and the like. Sensor(s) 112 may itself comprise processors and may provide location data (e.g., coordinates) directly to module 114 in some instances.

Gesture recognition module 116 configures computing device 102 to identify one or more gestures based on the location(s) of one or more touches. For example, as noted below, a single-touch input gesture can be identified if an object contacts the same or substantially the same touch location while the object changes orientation or otherwise moves in a detectable manner.

In addition to or instead of the single-touch gesture, module 116 may configure computing device 102 to identify a multi-touch input if one or more objects contact a first touch location and a second touch location at the same time and the first and second touch locations are mapped to first and second positions within a coordinate system of a graphical user interface (GUI) that are sufficiently near a third position. The multi-touch input gesture can be used as an input to affect one or more objects having GUI coordinates at or near the third position. For example, the third position can correspond to a position of a boundary or another GUI object that lays between the first and second positions in the GUI coordinates, with the boundary or other object moved or selected by way of the multi-touch gesture.

As used herein, “substantially the same” touch location is meant to indicate that embodiments allow for a tolerance level based on what occurs in practice—for example, a very high resolution system may determine a change in coordinates even if a user's finger or other object in contact with the touch surface does not perceptibly move or is intended to remain in the same place.

In some embodiments, recognizing various gestures comprises applying one or more heuristics to the received data from sensors 112 to identify an intended command. For example, module 116 may support one or more heuristic algorithms configured to analyze at least the touch location and optionally other information received over time from the sensors of the touch device. The heuristics may specify patterns of location/other information that uniquely correspond to a gesture and/or may operate in terms of determining a most likely intended gesture by disqualifying other potential gestures based on the received data.

For example, received data may indicate coordinates of a single touch along with information indicating the angle of the single touch. A heuristic may specify that, if the coordinates remain the same (or within a range tolerance) but the angle changes in a first pattern, then a first command is to be carried out (e.g., a scroll or other command in response to a single-touch gesture) while a second pattern corresponds to a second command. On the other hand, another heuristic may identify that two sets of coordinates indicating simultaneous touches disqualifies the first & second command. However, the other heuristic may specify that if the two simultaneous touches are within a specified range of another interface object, then the other object should be operated upon (e.g., selecting or moving the object).

Application(s)/Operating System 118 are included to illustrate that memory 108 may embody additional program components that utilize the recognized gesture(s). For instance, if computing device 102 executes one or more user programs (e.g., word-processing, media playback, or other software), the software can, in response to the single-touch input gesture, perform at least one of scrolling a display area (e.g., text or an image), rotating an object (e.g., rotate an image, page, etc.) or moving an object (e.g., move text, graphics, etc. being edited or to change selection in a list or menu). As another example, the operating system or an application can, in response to the multi-touch input gesture, perform at least one of resizing an object or moving an object boundary, such as increasing or decreasing the size of a window, increasing or decreasing the size of an image or other onscreen object, moving an element of the user interface such as a divider or separation bar in a page, etc.

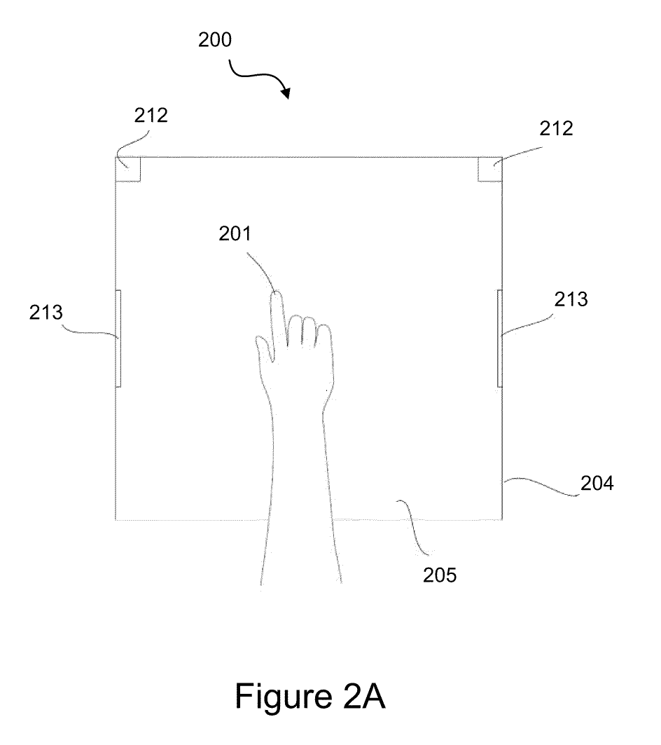

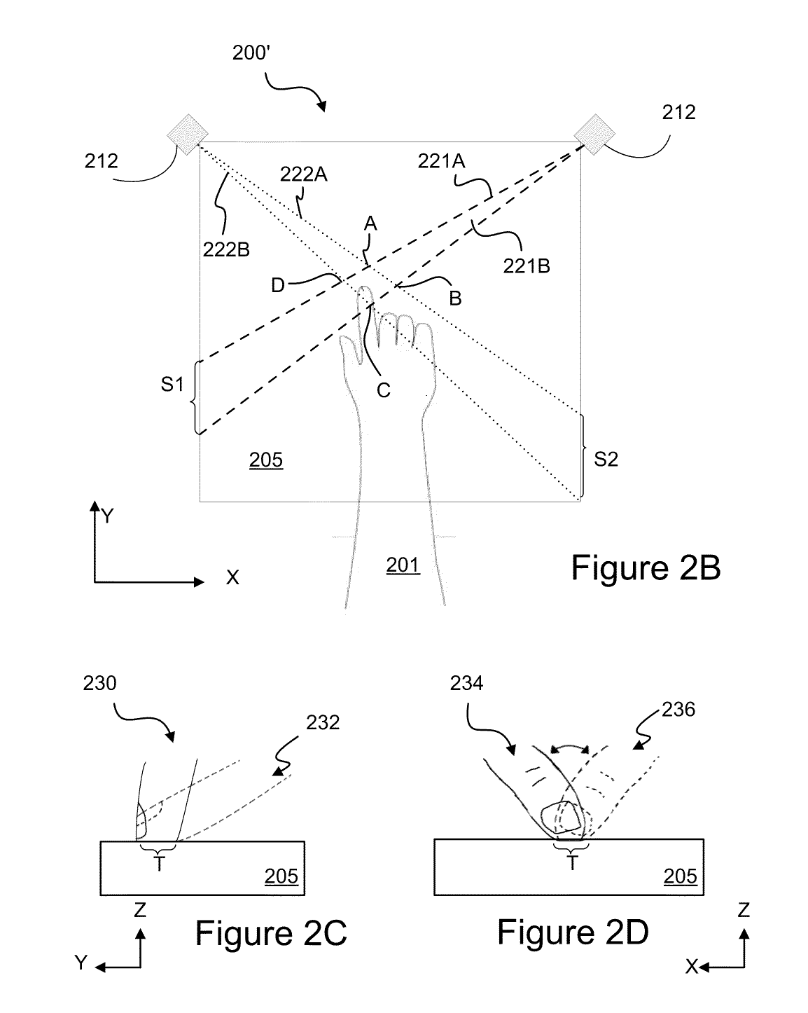

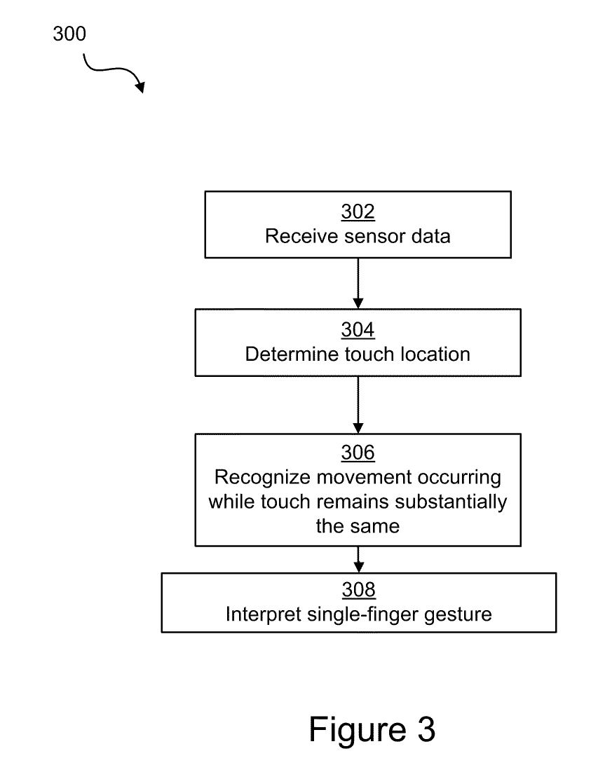

FIG. 2A shows an illustrative embodiment of a position detection system 200 comprising optical sensors and an exemplary object 201 touching a touch surface. Particularly, this example shows a touch sensitive display 204 defining a touch surface 205, which may be the top of the display or a material positioned over the display. Object 201 comprises a user's hand, though any object(s) can be detected, including, but not limited to one or more of a finger, hand, or stylus. Object 101 can interfere with an expected pattern of light traveling across the touch surface, which can be used to determine one or more input gestures.

Two optical sensors 212 are shown in this example along with two energy emitters 213. More or fewer sensors 212 and/or emitters 213 could be used, and in some embodiments sensors 212 utilize ambient light or light emitted from another location. In this example, the energy emitters 213 emit energy such as infrared or other light across the surface of the display 204. Sensors 212 can detect the presence of the energy so that anything placed on or near display 204 blocks some of the energy from reaching sensors 212, reflects additional energy towards sensors 212, and/or otherwise interferes with light above display 204. By measuring the absence of energy, the optical sensor 16 may determine the location of the blockage by triangulation or similar means.

For example, a detection module can monitor for a drop below a threshold level of energy and, if detected energy drops below the threshold, can proceed to calculate the location of the blockage. Of course, an optical system could also operate based on increases in light, such as by determining an increase in detected light reflected (or directed) into the sensors by the object and the example of utilizing a decrease in light is not intended to be limiting.

FIG. 2B illustrates a view 200′ of the coordinate detection system of FIG. 2A and showing how interference with light can be used to identify a single-touch gesture in some embodiments. In this view, the touch surface 205 can be described in x-y coordinates, with the z+ axis pointing outward from the page.

A touch point corresponding to the extended finger of hand 201 can be detected by optical sensors 212 based on blockage of light. Particularly, shadows S1 and S2 can be detected and borders 221A/221B and 222A/222B can be extrapolated from the shadows as detected by sensors 212 and the known optical properties and arrangement of the system components. The touch location may be determined by triangulation, such as projecting a line from the midpoint of each shadow (not shown) to each sensor 212, with the touch location comprising the intersection of the midpoint lines.

In accordance with the present subject matter, a single-touch input gesture can be identified based on an alteration in a shape defined by the bounding lines of the shadows while the triangulated position of the touch location remains at least substantially the same. The optical sensors 212 can sense minute amounts of energy, such that the tiniest movement of the finger of hand 201 can alter the quantity/distribution of sensed energy. In this fashion, the optical sensor can determine in which direction the finger is moving.

Particularly, the four points A, B, C, D where lines 221A/222A, 221B/222A, 222B/221B, and 221A/222B, respectively intersect can be defined as a substantially rhombus shaped prism ABCD, shown in exaggerated view in FIG. 2B. As the touch location is moved, the rhombus alters in shape and position. With the touch location remaining substantially the same, the size and shape of the rhombus still alters, particularly on the sides of the rhombus furthest from the optical sensors 212 (sides CD and CB in this example).

By altering the angle by which the finger contacts the touch surface, for example, the amount of energy passing to the optical sensors 212 is altered minutely, which can be detected by the optical sensors 212 and analyzed to determine a pattern in movement of the finger, with the pattern of movement used to identify a gesture.

FIGS. 2C and 2D illustrate example single-touch gestures defined in terms of changes in the orientation of a finger or other object in contact with a touch surface. In use, the finger may be placed at a point on the screen and the angle at which the finger 100 contacts the screen altered continuously or in a predetermined pattern. This altering of the angle, whilst still maintaining the initial point of contact can define a single touch gesture. It will be understood that the term “single touch gesture” is used for convenience and may encompass embodiments that recognize gestures even without contact with the surface (e.g., a “hover and roll” maneuver during which the angle of a finger or other object is varied while the finger maintains substantially the same x-y location).

FIG. 2C shows a cross-sectional view with the x-axis pointing outward from the page. This view shows a side of the finger of hand 201 as it moves about the x-axis from orientation 230 to orientation 232 (shown in dashed lines). The touch point T remains substantially the same. FIG. 2D shows another cross sectional view, this time with the y-axis pointing outward from the page. In this example, the finger moves from orientation 234 to 236, rotating about the y-axis. In practice, single-touch gestures may include either or both x-, −y, and/or z-axis rotation and/or may incorporate other detectable variances in orientation or motion (e.g., a bending or straightening of a finger). Still further, rotation about the finger's (or other object's) own axis could be determined as well.

Additional or alternative aspects of finger orientation information can be detected and used for input purposes based on changes in the detected light that can be correlated to patterns of movement. For example, movement while a finger makes a touch and is pointed “up” may be interpreted differently from when the finger is pointed “left,” “right,” or “down,” for instance. The direction of pointing can be determined based on an angle between the length of the finger (or other object) with respect to the x- or −y axis as measured at the touch point. In some embodiments, if finger movement/rotation is to be detected, then additional information about the rotation can be derived from data indicating an orientation of another body part connected to the finger (directly or indirectly), such as a user's wrist and/or other portions of the user's hand. For example, the system may determine orientation the wrist/hand if it is in the field of view of the sensors by imaging light reflected by the wrist/hand and/or may look for changes in the pattern of light due to interference from the wrist to determine a direction of rotation (e.g., counter-clockwise versus clockwise about the finger's axis).

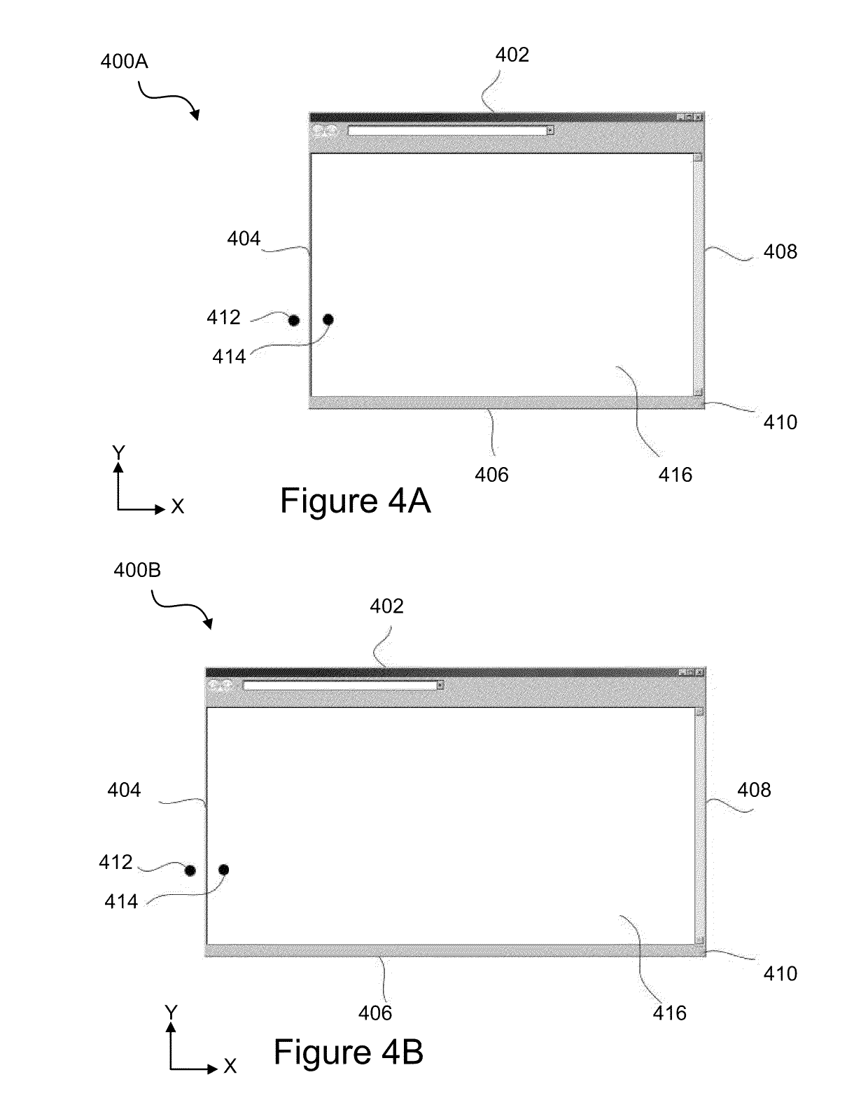

FIG. 3 is a flowchart showing steps in an exemplary method 300 for identifying a single-touch gesture. Generally speaking, in some embodiments a detection module can pass information relating to the location, angle and movement of the contact between the finger and screen to one or more other modules (or another processor) that may interpret the information as a single point contact gesture and perform a pre-determined command based upon the type of single point contact gesture determined.

Block 302 represents receiving data from one or more sensors. For example, if optical sensing technology is used, then block 302 can represent receiving data representing light as sensed by a linear, area, or other imaging sensor. As another example, block 302 can represent sampling an array of resistive, capacitive, or other sensors comprised in the touch surface.

Block 304 represents determining a location of a touch. For instance, for an optical-based system, light from a plurality of sensors can be used to triangulate a touch location from a plurality of shadows cast by an object in contact with the touch surface or otherwise interfering with light traveling across the touch surface (i.e. by blocking, reflecting, and/or refracting light, or even serving as a light source). Additionally or alternatively, a location can be determined using other principles. For example, an array of capacitive or resistive elements may be used to locate a touch based on localized changes in resistance, capacitance, inductance, or other electrical characteristics.

Block 306 represents recognizing one or more movements of the object while the touch location remains substantially the same. As noted above, “substantially the same” is meant to include situations in which the location remains the same or remains within a set tolerance value. Movement can be recognized as noted above, such as by using an optical system and determining variances in shadows that occur although the triangulated position does not change. Some embodiments may define a rhombus (or other shape) in memory based on the shadows and identify direction and extent of movement based on variances in sizes of the defined shape. Non-optical systems may identify movement based on changes in location and/or size of an area at which an object contacts the touch surface.

Block 308 represents interpreting the single-finger (or other single-touch) gesture. For example, a detection algorithm may set forth a threshold time during which a touch location must remain constant, after which a single-touch gesture will be detected based on movement pattern(s) during the ensuing time interval. For example, a device driver may sample the sensor(s), recognize gestures, and pass events to applications and/or the operating system or location/gesture recognition may be built into an application directly.

Various single point contact gestures will now be noted below for purposes of example, but not limitation; many such gestures may be defined in accordance with the present invention.

### Rotate

In the rotate gesture, the finger is placed upon the screen and rolled in a clockwise or anti clockwise motion (simultaneous movement about the x- and y-axes of FIGS. 2B-2D). The rotate gesture may be interpreted as a command to rotate an image displayed on the screen. This gesture can be useful in applications such as photo manipulation.

### Flick

In the flick gesture, the finger is placed upon the screen and rocked back and forth from side to side (e.g. about the y-axis of FIGS. 2B/2D). The flick gesture may be interpreted as a command to move between items in a series, such as between menu items, moving through a list or collection of images, moving between objects, etc. This gesture can be useful in switching between images displayed on a screen such as photographs or screen representations or serving in place of arrow keys/buttons.

### Scroll

In the scroll gesture, the finger is placed upon the screen and rocked and held upwards, downwards or to one side. The scroll gesture may be interpreted as a command to scroll in the direction the finger is rocked. This gesture can be useful in applications such as a word processor, web browser, or any other application which requires scrolling upwards and downwards to view text and/or other content.

As mentioned above, additional embodiments include systems, methods, and computer-readable media for providing multi-touch gestures. Some embodiments support both single-touch and multi-touch gestures, while other embodiments include gestures of the single-touch type, but not the multi-touch type, or vice-versa. Of course, any embodiment noted herein can be used alongside additional gestures and other input techniques that would occur to one of skill in the art upon review of the present disclosure.

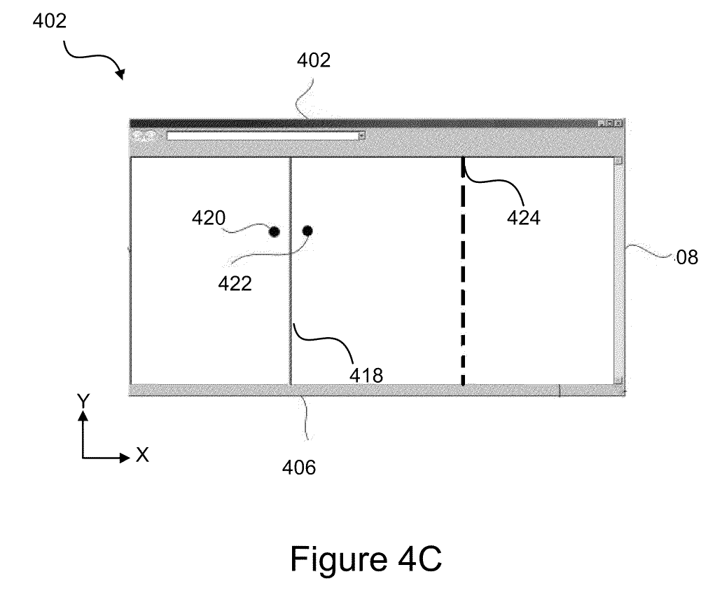

FIGS. 4A-4C illustrate exemplary graphical user interfaces during a multi-touch gesture. Particularly, FIG. 4A shows a graphical user interface 400A comprising a window 402. Window 402 (or other interface components) may be defined as a plurality of points on an x and y axis using Cartesian coordinates as would be recognized by a person skilled in the art. For use with a coordinate detection system, pixels in the graphical user interface can be mapped to corresponding locations in a touch area.

As shown in FIGS. 4A-4C, the window comprises a top horizontal border and title bar, left vertical border 404, bottom horizontal border 406, and right vertical border (with scrollbar) 408. Optionally, the window may further comprise a resize point 410 at one or more components. Window 402 is meant to be representative of a common element found in most graphical user interfaces (GUI) available, these include Microsoft Windows®, Mac OS®, Linux™, and the like.

As mentioned previously, typically resizing is performed by clicking a mouse and dragging along an external border of an object on a display and/or a resizing point. A touch-enabled system may support such operations, e.g., by mapping touches to click events. One potential problem with such a technique may result due to a size difference between a touch point and graphical user interface elements. For example, the resize point 410 and/or borders may be mapped to locations in the touch surface, but it may be difficult for the user to precisely align a finger or other object with the mapped location if the user's finger maps to a much larger area than the desired location. As a particular example, the mapping between touch area coordinates and GUI coordinates may not be direct—for example, a small area in the touch area may map to a much larger range in the GUI coordinates due to size differences.

Resizing may be performed according to one aspect of the present subject matter by recognizing a multi-touch input gesture during which one or more objects contact a first touch location and a second touch location at the same time, the first and second touch locations mapped to first and second positions within a graphical user interface in which a graphical user interface object is defined at a third position, the third position laying between the first and second position or otherwise proximate to the first and second positions. In this example, the graphical user interface object comprises border 404, and so the window can be resized by touching on either side of border 404 as shown at 412 and 414.

Particularly, a user may contact two fingers or other object(s) as shown at 412 on side of left vertical border 404 and a second contact 414 on the opposite side of left vertical border 404. The contacts 402 and 404 can be detected using optical, resistive, capacitive, or other sensing technology used by the position detection system. Particularly, the Cartesian coordinates can be determined and passed to a gesture recognition module.

The gesture recognition module can calculate a central position known as a centroid (not shown) between the two contact points 412 and 414, for example by averaging the x and y Cartesian coordinates of the two contact points 412 and 414. The centroid can be compared with a pre-determined threshold value defining a maximum number of pixels the centroid position must be away from a GUI coordinate position corresponding to the window border or other GUI object for the multi-touch gesture to be activated.

By way of example the threshold may be “3”, whereby if the centroid is within 3 pixels of a window border 404, 406, 408, etc. a resize command is activated. The resize command may be native to an operating system to allow resizing of window 402 in at least one direction. Either or both touch points 412 and/or 414, such as by dragging fingers and/or a stylus along the display. As the contact(s) is/are moved, the window 402 can be resized in the direction of the movement, such as shown at 400B in FIG. 4B, where points 412 and 414 have been dragged to the left (x-minus) direction.

For instance, a user may utilize his or her fingers—typically the index and middle fingers—to contact either side of a portion of an object on a display. The computing device can recognize the intent of the contact due to its close proximity to a portion of the object. After the operation is complete, the end of the gesture can be recognized when the user removes both fingers from proximity with the display.

In some embodiments, touch locations 412 and 414 can be recognized when made substantially simultaneously or if made consecutively within a time interval. Additionally or alternatively, the movement of one or more points can be in the as horizontal, vertical or diagonal direction. As an example, a user may place one touch point in interior portion 416 of window 402 and another touch point opposite the first touch point with resize point 410 therebetween. Then, either or both points can be moved to resize the window.

FIG. 4C shows another example of selecting an object using a multitouch gesture. Particularly, window 402 features a divider/splitter bar 418. Splitter bar 418 can comprise a substantially vertical or horizontal divider which divides a display or graphical user interface into two or more areas. As shown in FIG. 4C, a touches 420 and 422 on either side of splitter bar 418 may be interpreted as a command to move splitter bar 418, e.g., to location 424 by dragging either or both points 420, 422 to the right (x-plus) direction.

Other commands may be provided using a multitouch gesture. By way of example, common window manipulation commands such as minimize, maximize, or close may be performed using a touch on either side of a menu bar featuring the minimize, maximize, or close command, respectively. The principle can be used to input other on-screen commands, e.g., pressing a button or selecting an object or text by placing a finger on opposite sides thereof. As another example, a touch on opposite sides of a title bar may be used as a selection command for use in moving the window without resizing.

Additionally, objects other than windows can be resized. For example, a graphical object may be defined using lines and/or points that are selected using multiple touches positioned on opposite sides of the line/point to be moved or resized.

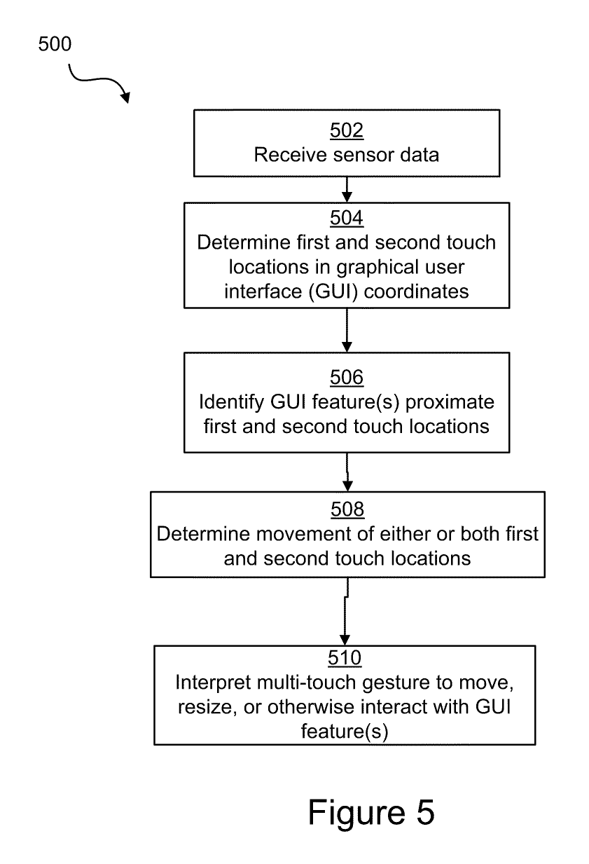

FIG. 5 is a flowchart showing steps in an exemplary method 500 for identifying a multi-touch gesture. Block 502 represents receiving sensor data, while block 504 represents determining first and second touch locations in graphical user interface (GUI) coordinates. As noted above, touch locations can be determined based on signal data using various techniques appropriate to the sensing technology. For example, signal processing techniques can be used to determine two actual touch points from four potential touch points by triangulating four shadows cast by the touch points in an optical-based system as set forth in U.S. patent application Ser. No. 12/368,372, filed Feb. 10, 2009, which is incorporated by reference herein in its entirety. Additionally or alternatively, another sensing technology can be used to identify touch locations. Locations within the touch area can be mapped to positions specified in graphical user interface coordinates in any suitable manner. For example, the touch area coordinates may be mapped directly (e.g., if the touch area corresponds to the display area). As another example, scaling may be involved (e.g., if the touch area corresponds to a surface separate from the display area such as a trackpad).

Block 506 represents identifying one or more graphical user interface features at a third position proximate the first and second positions, with the first and second positions representing the GUI coordinates that are mapped to the first and second touch locations. The third position may be directly between the first and second positions (e.g., along a line therebetween) or may at another position. Identifying a graphical user interface feature can comprise determining if the feature's position lay within a range of a centroid calculated as an average between the coordinates for the first and second positions as noted above. For example, an onscreen object such as a window border, splitter bar, onscreen control, graphic, or other feature may have screen coordinates corresponding to the third position or falling within the centroid range.

Block 508 represents determining a movement of either or both the first and second touch locations. For example, both locations may change as a user drags fingers and/or an object across the screen. Block 510 represents interpreting the motion as a multi-touch gesture to move, resize, or otherwise interact with the GUI feature(s) corresponding to the third position.

For example, if the GUI feature is a window or graphic border, then as the touch point(s) is/are moved, the window or graphic border may be moved so as to resize the window or object.

As noted above, some multi-touch commands may utilize the first and second touch points to select a control. Thus, some embodiments may not utilize the movement analysis noted at block 508. Instead, the gesture may be recognized at block 510 if the multitouch contact is maintained beyond a threshold time interval. For example, if a first and second touch occur such that a control such as a minimize, maximize, or other button lies within a threshold value of the centroid for a threshold amount of time, the minimize, maximize, or other button may be treated as selected. Also, as noted above with respect to the single-touch gesture, some embodiments can recognize the multi-touch gesture even if a “hover” occurs but no contact occurs.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

Certain of the above examples referred to various illumination sources and it should be understood that any suitable radiation source can be used. For instance, light emitting diodes (LEDs) may be used to generate infrared (IR) radiation that is directed over one or more optical paths in the detection plane. However, other portions of the EM spectrum or even other types of energy may be used as applicable with appropriate sources and detection systems.

The various systems discussed herein are not limited to any particular hardware architecture or configuration. As was noted above, a computing device can include any suitable arrangement of components that provide a result conditioned on one or more inputs. Suitable computing devices include multipurpose and specialized microprocessor-based computer systems accessing stored software, but also application-specific integrated circuits and other programmable logic, and combinations thereof. Any suitable programming, scripting, or other type of language or combinations of languages may be used to construct program components and code for implementing the teachings contained herein.

Embodiments of the methods disclosed herein may be executed by one or more suitable computing devices. Such system(s) may comprise one or more computing devices adapted to perform one or more embodiments of the methods disclosed herein. As noted above, such devices may access one or more computer-readable media that embody computer-readable instructions which, when executed by at least one computer, cause the at least one computer to implement one or more embodiments of the methods of the present subject matter. When software is utilized, the software may comprise one or more components, processes, and/or applications. Additionally or alternatively to software, the computing device(s) may comprise circuitry that renders the device(s) operative to implement one or more of the methods of the present subject matter.

Any suitable non-transitory computer-readable medium or media may be used to implement or practice the presently-disclosed subject matter, including, but not limited to, diskettes, drives, magnetic-based storage media, optical storage media, including disks (including CD-ROMS, DVD-ROMS, and variants thereof), flash, RAM, ROM, and other memory devices, and the like.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

What is claimed:

1. A position detection system, comprising:
at least one sensor configured to provide data indicating one or more touch locations on a touch surface;
a processor interfaced to the at least one sensor and configured to identify the one or more touch locations from the sensor data,
wherein the processor is configured to recognize at least one of:
a single-touch input gesture during which an object contacts the same or substantially the same touch location while the object changes orientation, or
a multi-touch input gesture during which one or more objects contact a first touch location and a second touch location at the same time, the first and second touch locations mapped to first and second positions within a graphical user interface in which a graphical user interface object is defined at a third position, the third position laying proximate the first and second positions.

2. The position detection system set forth in claim 1, wherein recognizing at least one of the single-touch or multi-touch gesture comprises:
providing the sensor data to one or more heuristic algorithms, the one or more heuristic algorithms configured to analyze at least touch location to determine an intended command.

3. The position detection system set forth in claim 1,
wherein the sensor comprises an optical sensor, and
wherein the processor is configured to recognize at least one of the input gestures based on determining interference by the object or objects with an expected pattern of light.

4. The position detection system set forth in claim 3, wherein the system comprises at least two optical sensors and the processor is configured to recognize at least one of the touch locations based on triangulating a position of the touch location from a plurality of shadows cast by the object or objects.

5. The position detection system set forth in claim 4, wherein the processor is configured to identify bounding lines of each of the shadows and to recognize the single-touch input gesture based on an alteration in a shape defined by the bounding lines of the shadows while the triangulated position of the touch location remains at least substantially the same.

6. The position detection system set forth in claim 5, wherein the alteration in shape is due at least in part to a change in an orientation of a finger as the finger rotates about its own axis, the direction of the rotation determined based on additional sensor data indicating a change in orientation of a body part in connection with the finger.

7. The position detection system set forth in claim 1, wherein the system is configured to recognize the multi-touch input gesture if the first and second touch locations are mapped to first and second positions within a graphical user interface in which a graphical user interface object is defined at a third position, the third position laying within a range of a centroid defined using coordinates of the first and second positions.

8. The position detection system set forth in claim 1, wherein the system is configured to, in response to the single-touch input gesture, perform at least one of:
scrolling a display area;
rotating an object; or
moving an object.

9. The position detection system set forth in claim 1, wherein the system is configured to, in response to the multi-touch input gesture, determine whether one or both of the first and second touch locations move and, in response, perform at least one of:
resizing the graphical user interface object in response to a change of at least one of the first and second touch location or
moving the graphical user interface object in response to a change of at least one of the first and second touch location.

10. A method, comprising:
receiving, from at least one sensor, data indicating one or more touch locations on a touch surface;
identifying, by a processor, the one or more touch locations from the sensor data; and
recognizing at least one of:
a single-touch input gesture during which an object contacts the same or substantially the same touch location while the object changes orientation, or
a multi-touch input gesture during which one or more objects contact a first touch location and a second touch location at the same time, the first and second locations mapped to first and second positions within a graphical user interface in which a graphical user interface object is defined at a third position, the third position proximate the first and second position.

11. The method set forth in claim 10,
wherein the sensor comprises an optical sensor, and
wherein recognizing at least one of the input gestures comprises determining interference by the object or objects with an expected pattern of light.

12. The method set forth in claim 11, wherein receiving comprises receiving data from at least two optical sensors and recognizing comprises triangulating a position of at least one touch location from a plurality of shadows cast by the object or objects.

13. The method set forth in claim 12, wherein recognizing comprises identifying bounding lines of each of the shadows, the single-touch input gesture recognized based on identifying an alteration in a shape defined by bounding lines of the shadows while the triangulated position of the touch location remains at least substantially the same.

14. The method set forth in claim 10, wherein recognizing comprises:
recognizing the multi-touch input gesture if the first and second touch locations are mapped to first and second positions within a graphical user interface in which a graphical user interface object is defined at a third position and the third position lays within a range of a centroid defined using coordinates of the first and second positions.

15. The method set forth in claim 10, further comprising, in response to the single-touch input gesture, performing at least one of:
scrolling a display area;
rotating an object; or
moving an object.

16. The method set forth in claim 10, further comprising, in response to multi-touch input gesture, performing at least one of:
resizing the graphical user interface object; or
moving the graphical user interface object.

17. A nontransitory computer-readable medium embodying program code executable by a computing system, the program code comprising:
code that configures the computing system to receive, from at least one sensor, data indicating one or more touch locations on a touch surface;
code that configures the computing system to identify the one or more touch locations from the sensor data; and
code that configures the computing system to recognize at least one of:
a single-touch input gesture during which an object contacts the same or substantially the same touch location while the object changes orientation, or
a multi-touch input gesture during which one or more objects contact a first touch location and a second touch location at the same time, the first and second touch locations mapped to first and second positions within a graphical user interface in which a graphical user interface object is defined at a third position, the third position laying between the first and second position.

18. The computer-readable medium set forth in claim 17,
wherein the code that configures the computing system to recognize at least one of the input gestures comprises code that configures the computing system to determine interference by the object or objects with an expected pattern of light based on data received from at least one optical sensor.

19. The computer-readable medium set forth in claim 18,
wherein the code that configures the computing system to recognize at least one of the input gestures comprises code that configures the computing system to triangulate a position of at least one touch location from a plurality of shadows cast by the object or objects by using data from at least two optical sensors.

20. The computer-readable medium set forth in claim 19,
wherein the code that configures the computing system to recognize at least one of the input gestures comprises code that configures the computing system to determine bounding lines of each of the shadows and to recognize the single-touch input gesture based on identifying alterations in a shape defined by bounding lines of the shadows while the triangulated position of the touch location remains at least substantially the same.

21. The computer-readable medium set forth in claim 17, further comprising code that configures the computing system to, in response to the single-touch input gesture, perform at least one of:
scrolling a display area;
rotating an object; or
moving an object.

22. The computer-readable medium set forth in claim 17, further comprising code that configures the computing system to, in response to multi-touch input gesture, perform at least one of:
resizing the graphical user interface object; or
moving the graphical user interface object.
